(19) United States
(12) Patent Application Publication
(10) Pub. No.: US 2003/0084920 A1
(43) Pub. Date: May 8, 2003

(54) Bucket - razor

(76) Inventor: Randy Richard Sawtelle, Barnardsville, NC (US)

Correspondence Address: RANDY RICHARD SAWTELLE, 355 PAINT FORK RD., BARNARDSVILLE, NC, 28709-9776, US

(21) Appl. No.: 10/287,763

(22) Filed: Nov. 4, 2002

Related U.S. Application Data
(60) Provisional application No. 60/337,799, filed on Nov. 7, 2001.

(51) Int. Cl. B08B 7/00

(52) U.S. Cl. 134/6; 15/236.1; 15/93.1

(57) ABSTRACT

The Bucket-Razor presents a method for removing various items from hard surfaces. Such surfaces can be Asphalt and concrete, but not limited to these. The device can be attached to any front-end loader piece of equipment, such as, but not limited to skid steer tractors, backhoes, farm tractors, any front-end loader. The unit is designed to fit a large range of different size and thickness buckets. It can, by use of setscrews, be held in place. Once unit is attached to the bucket, a cutting blade is inserted into unit. This blade also is held in place by countersunk setscrews. This blade being mainly spring steel and of such a thickness and hardness to allow it to get under and cut objects stuck to hard surfaces. Several blade widths are possible up to 16″. The unit itself can be positioned at any point on the bottom plate of the bucket from one side to other side. Removing is accomplished, by the spring steel being forced under the object, by the forward motion of the front-end loader. The angle of the unit and bucket it is mounted to, determines aggressiveness of attack.

### CROSS REFERENCE TO PROVISIONAL PATENT APPLICATION

The benefit of the U.S. Provisional Application No. 60/337,799, Filed Nov. 7, 2001, is claimed.

### BACK GROUND OF THE INVENTION

The present invention relates generally to the removal of objects stuck to a hard surface. Such as, but not limited to, Temporary and permanent marking tapes, here after known as (PMT), Raised pavement marking reflectors, here after referred to as (RPM), Ceramic marking Buttons, here by known as (CMB), more particularly, to efficient methods and tools for removing a variety of objects that are adhered or stuck to a hard surface using a variety of mastics.

The marking tapes (PMT) are commonly used on both highways and parking lots. They are used both to divert traffic in a temporary fashion on highways, as well as, to serve as permanent markings. They are designed to withstand a large variety of attacks; weather, traffic, time to mention a few. They are held to the surface by mastic. Each company's product uses a different formula for this mastic, but all have the goal with these markings, which is to make them durable.

There is a need for efficient removal of these tapes (PMT) at various times. Due to new traffic patterns or just simply worn out markings. In view of the permanent nature of these products they do not come off easily. Even the so-called temporary PMT is likely to come apart, rather than let go of the surface. This proves to make it a very time consuming and labor intensive operation. Usually performed by pulling by hand or attaching it to the back of a truck. The difficulty comes when the tape starts to come apart, which is normal. It is not uncommon for it to come up in strips of no more than an inch in width and long, sometimes even less. When the PMT has been run over a lot or is applied in a hot climate this again interisifies its adhesion to the surface. This necessitates taking the remaining PMT off with putty knives and razor blades one little piece at a time. This is a universal problem with removing PMTs.

Water blasting has been tried. This takes the tape off but tends to turn it into even smaller strips and splatters the tape all over the roadway and any nearby objects. When dry it is stuck again to the road surface and everything else. As it is made to reflect light, it is really confusing at night as a whole area may appear to be painted the PMTs color and can and does confuse the motoring public. It also leaves a misleading mark in the form of un-removed mastic.

Another method is Grinding. Although this does remove the PMT it also cuts it in to small pieces. This method also does a certain amount of damage to the surface. This damage is unacceptable to the department of transportation for many reasons. One of the main reasons is it leaves a misleading mark on the road surface. All these methods leave a mess on the road way as well as putting workers in harms way for a long period of time. It's very dangerous for the traveling public as they drive through the areas where this work is being done.

Raised Pavement Markers (RPM) are commonly used in the warmer climates. It embodies a 2×4″ or a 4″×4″ stick on reflector to the road surface. It normally comes in traffic yellow and white. And sometimes blue is used to identify were fire hydrants are. These RPMs are applied to the surface in 3 main ways. One is hot bituminous application. The bituminous is heated to 425 degrees and put down hot on the surface and before it cools off the RPM is stuck in it. Another method is using epoxies. After the epoxy is applied to the surface the RPM is stuck in it. Another is sticky pads, that uses a combination of either a sticky mastic or a heat-able pad.

These are used in a variety of ways: to delineate the centerline, edge line or even a traffic island. They are used in some states as the only pavement marking to divert traffic in a temporary and permanent traffic patterns.

When used in a temporary fashion they have to be removed when traffic is switched to the permanent pattern. This is commonly done by a claw type hammer and some times a chisel. This is very time consuming and dangerous. As often as not you are in the middle of 2 lanes of traffic bent over swinging a hammer. This method does not get all the mastic off. So it leaves a big black puddle of mastic on the road surface, which can mislead the traveling public. Most states now require this mastic to be removed as well, for this reason.

You can also remove them with a Grinder. This works well but tends to shatter the RPM and can fling shards out into traffic, as well as, possible damage to the road surface.

You can use a motor grader blade. The problem here is traffic interference and the fact that it often does a lot of damage to the paved surface. All these methods work in a limited way. They all leave debris on the road surface as well as misleading marks and some of them even damage the road surface.

Ceramic Buttons (CMB) are used in some of the same ways as the RPM. In many western states it is used in place of the centerline markings whether they are the white line or the yellow. They do not have any reflective capabilities so they are usually used in conjunction with RPMs. The CMBs tend to get driven into the surface by traffic so this makes them very hard to remove. They are applied in all the same ways as the RPMs. But are harder to get off the surface. They tend to shatter more readily than RPMs so flying shards is a big danger. Again in all these cases the PMT, RPMs and the CMB removal is done mostly by hand by a walking worker with a hammer and or chisel. Some times they use go-carts or low cars with out doors to get between each marker. All in all very labor intensive and highly dangerous work due to the long exposure time to working in moving traffic.

### SUMMARY OF THE INVENTION

Briefly, this invention acts as a razor blade mounted to a front-end loader. It facilitates and can be employed for effective and highly acceptable removal of but not limited to the aforementioned products.

Advantageously, the Bucket-Razor can be mounted to any front-end loader. It can be placed in any position on the bucket so as to limit amount of traffic interference. And as these types of equipment are commonly found on most projects, makes a simple and convenient way to remove the various items from hard surfaces.

The method and tool of the Bucket-Razor will remove, both the item and most, if not all of the mastic that was holding it down. This is a greatly desired result. It removes the problem of misleading markings left behind, thus providing a smooth clean surface for new markings or surfaces to be applied without contamination from old markings or mastics. It also is designed in such a way that most removed items end up in the bucket holding the Razor, thus proving to be very labor efficient and safer. As well as, providing for less time in the roadway, which allows for less motoring public hindrance and probable damage or injury, due to workers on foot present in roadway for extend amounts of time, as well as, reducing the chance of shards flying out into traffic.

The Bucket-Razor itself is made from very heavy steel and will last indefinitely. The cutter blades are made of spring steel and are self-sharping. They are relatively inexpensive to replace.

In contrast to the normally used methods of removal this is fast, self cleaning and safer for workers and the motoring public. The surface left behind is more appealing to the Department of Transportation as no misleading marks are left. It also allows for a cleaner surface, which facilitates application of and adhesion of other products. And is less labor intensive. With the ability to mount, to already existing construction equipment it becomes a minor removal problem, instead of a very complex one.

In One embodiment, the Bucket-Razor is 16″ wide. This can be made to any width deemed needed without any re-engineering.

### BRIEF DESCRIPTION OF THE DRAWINGS

While the novel features of the invention are set forth with particularity in the appended claims, the invention both as to organization and content, will be better understood and appreciated from the following detailed and description, taken in conjunction with the drawings, in which:

FIG. 1 is a right side view (as seen from the operators seat as to relation to Side shown) depicting the various parts and overall shape of the Bucket-Razor. As well as there relative positions.

FIG. 2 is a Top View of the Bucket-Razor showing various parts and configurations of parts, as well as their relative positions.

FIG. 3 is the side view technical drawing with specifications and measurements

FIG. 4 is a top view technical drawing with specifications and measurements.

FIG. 5 is a highly schematic representation of a front-end loader with the Bucket razor mounted in the proper operational way.

### DETAILED DESCRIPTION

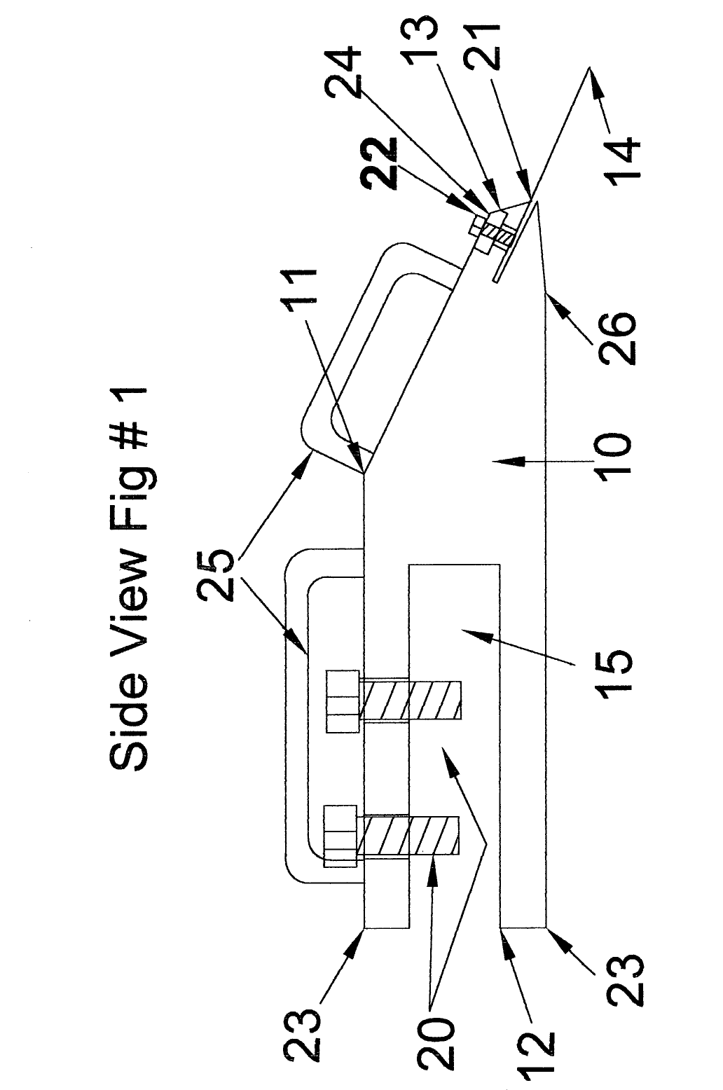

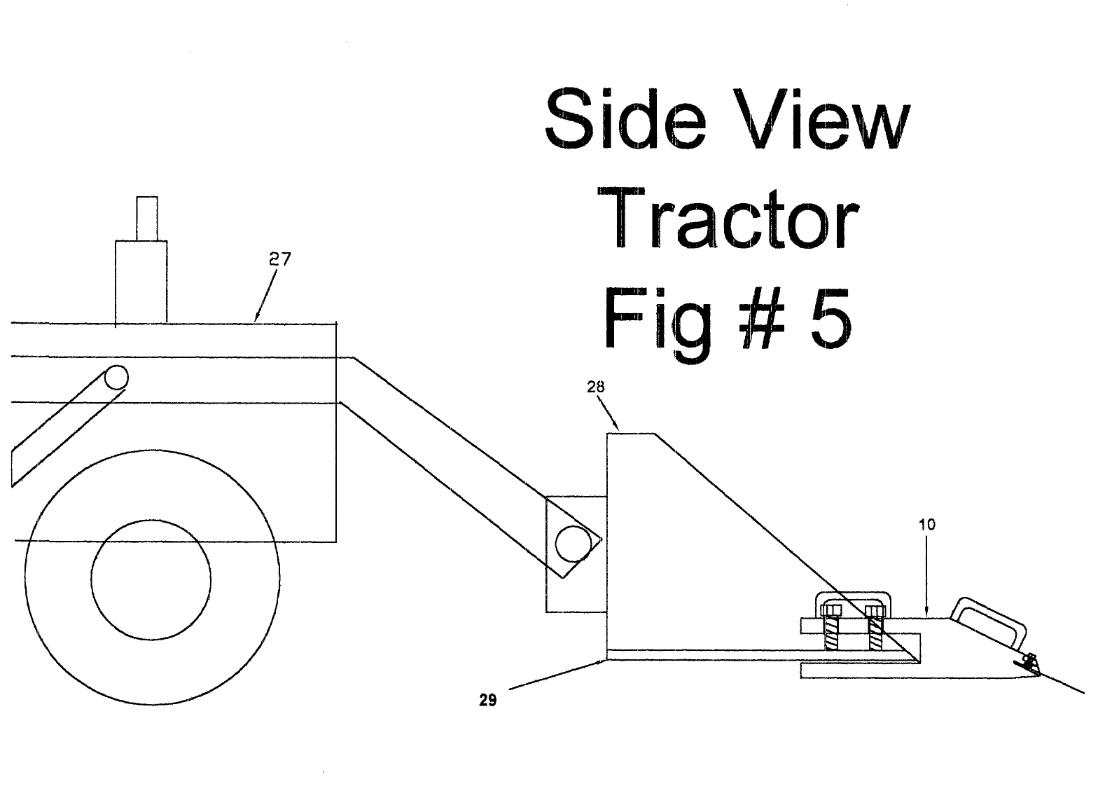

Referring first to FIG. 1 illustrates a Bucket-Razor apparatus 10 according to an embodiment of the invention. The proximal end 12,23 is configured to receive and attach to a plate of the bucket FIG. 5-29 and distal end 13 is configured to receive and to attach to a scrape plate 14 (spring steel). Specifically, the proximal end 12 of the invention 10 fines a bucket plate slot 15 and a scrape plate slot 21 for receiving the scrape plate 14. The bucket plate slot 15 and the scrape plate slot 21 are appropriately dimensioned for receiving the bucket plate FIG. 5-29 and the scrape pate 14, respectively.

Bucket plate slot 15 is assembled and used as follows. To mount the invention 10 to or on the bucket FIG. 5-28, the bucket plate FIG. 5-29 is inserted into the bucket plate slot 15. The invention 10 is then fastened to the bucket using setscrews 20 such as a plurality of screws. Setscrews are sufficiently tightened to bucket plate, so as not to allow any movement of the invention 10. Such buckets FIG. 5-28 and associated equipment are well known to those of ordinary skill in the art and are shown in FIG. 5. The scrape plate 14 is inserted into the scrape plate slot 21 and is attached by setscrews 22 such as a plurality of screws counter sunk as to facilitate easy movement of cut materials into the bucket FIG. 5-28. Once the invention 10 is attached to the bucket plate FIG. 5-29 and the scrape plate 14, the piece of construction equipment having the bucket FIGS. 5-27,28 may be positioned on a road in sufficient proximity to the highway and or surface of objects to be removed. By placing the invention appropriately on the bucket plate FIG. 5-29, you can lessen your exposure to hazards, such as, but not limited to existing traffic flow.

The embodiment shown in FIG. 1 shows a taper 11 or angle relative to the bottom of a bucket and or bucket plate FIG. 5-29, in order to obtain a premium angle to facilitate scrape blade 14 to cut into the objects to be removed, relative to the surface to which they are attached. The angle shown 26 on the bottom towards the proximal end 13 is used to facilitate proper cutting without hindrance of surface contact. The taper 24 and 11 provides a deflection and sloped guide surface in order to move cut materials up the face of the invention 10 and thereby ending up in the bucket FIG. 5-28. Number 25 has a dual purpose, as well as, acting as handles for easy handling of and or moving of the invention 10, it acts as a further guide for cut materials eventually ending up in the bucket FIG. 5-28 of the front end loader FIG. 5-27. Counter sunk plurality of setscrews 22 removes any hindrance of cut materials moving up 13,11 and into the bucket. For future disposal.

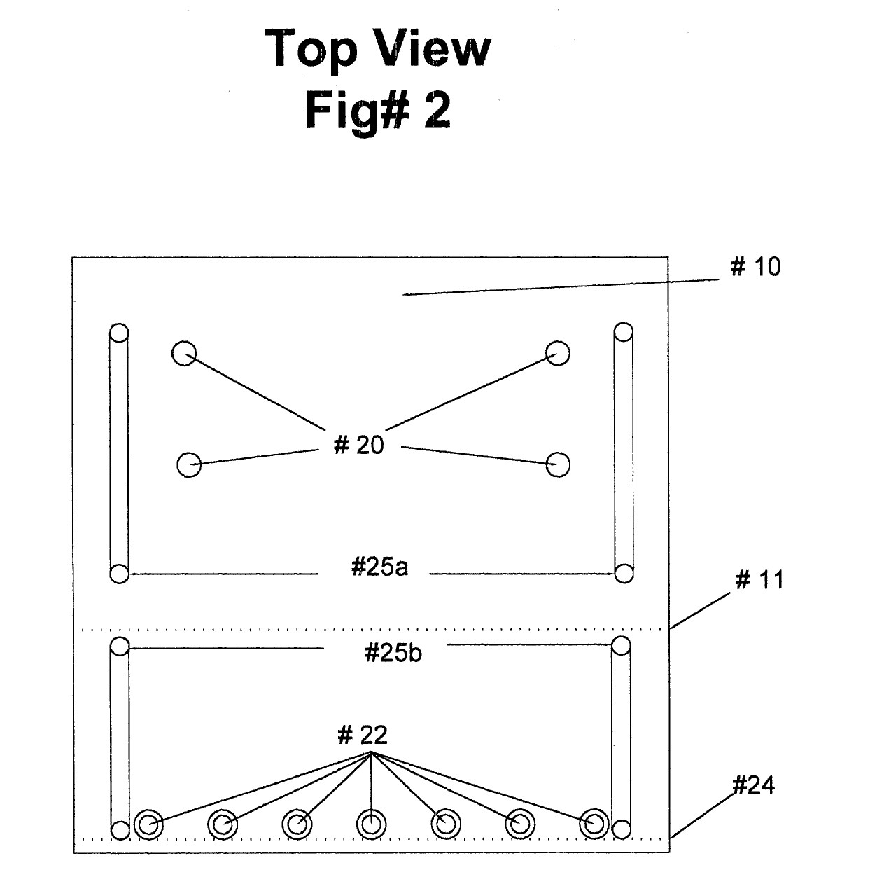

FIG. 2 illustrates one possible configuration of the fasteners set screws 20,22 on invention 10. It also shows the relative configuration of the handle/guides 225a, 25b. Once the invention 10 is attached to the bucket plate FIG. 5-29 and the scrape plate 14, the piece of construction equipment having the bucket FIG. 5-27 may be positioned on a road or other surface in sufficient proximity to the objects to be removed. The bucket FIG. 5-28 may then be manipulated in such, that the scrape plate 14, is above the objects to be removed. Finally the bucket FIG. 5-28 is manipulated such that the scrape plate 14 strikes and scrapes and or cuts the objects to be removed until sufficient removal from the surface has occurred. In this way a piece of equipment traditionally available to and frequently on site-such as a front-end loader FIG. 5-27 or backhoe-may be used in combination with the Bucket-Razor 10 of present invention to remove objects stuck to a hard surface.

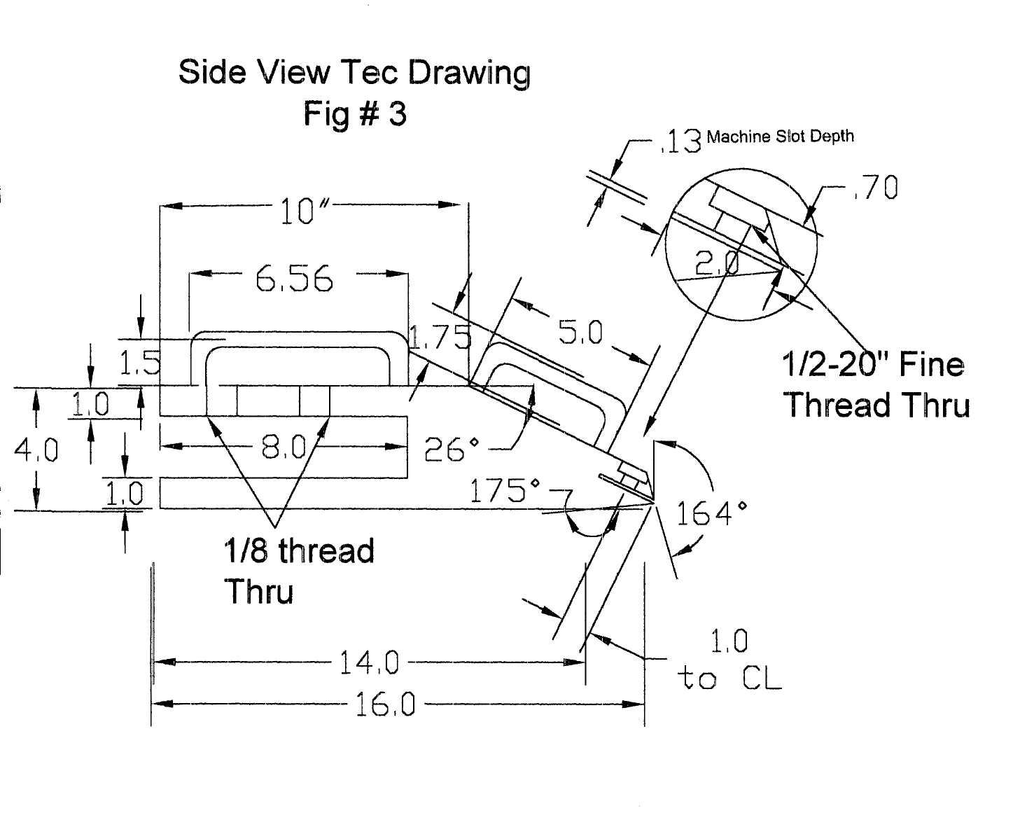

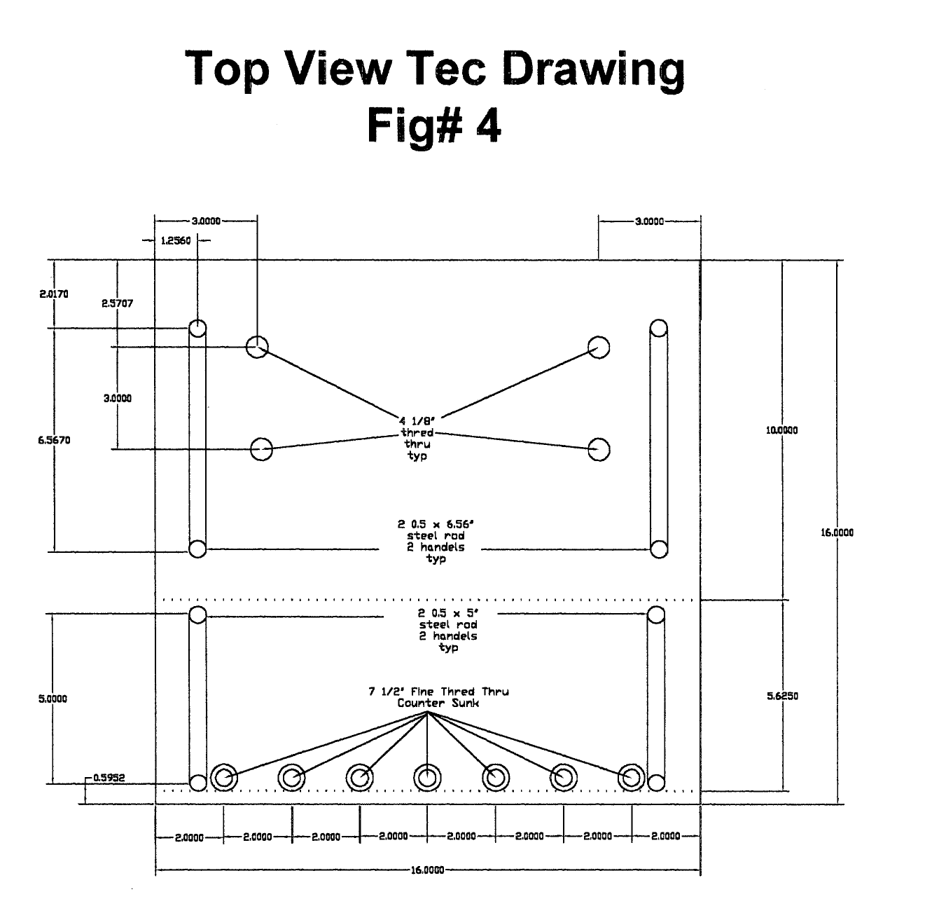

FIGS. 1 and 2 illustrate one possible set of dimensions and compositions for the parts of the Bucket-Razor apparatus 10 of the present invention. Many other sets of dimensions and compositions may be utilized without detraction from the performance of the present invention and without exceeding the scope thereof This is particularly true in light of the varying sizes of buckets FIG. 5-28 and associated construction or maintenance equipment FIG. 5-27, as well as the varying compositions and configurations of objects to be removed from hard surfaces. In one embodiment of the invention, as shown in FIGS. 1, 2, 3, 4 the invention 10 may be approximately 16 inches in length and approximately 16 inches in width. The Bucket plate slot 15 may be approximately 8 inches deep and 16 inches wide, while the scrape plate slot 21 may be approximately 16 inches long and 2 inches deep. The bucket plate slot 15 may be approximately 2 inches high, while the scrape plate slot may be approximately ⅛ inch high. The proximal end 12 of the invention 10 may be approximately 4 inches high, with the bucket plate slot 15 defined therein by two walls 23, each of the walls 23 being approximately 1 inch high. The fastener 20 used to attaché the invention 10 to the bucket plate FIG. 5-29 may be a plurality of screws with shanks approximately ⅛ inch in diameter, the fastener 22 used to attach the bracket 11 to the scrape plate 14 may be a plurality of screws with shanks approximately ½ inch. The invention may be composed of steel or another suitably durable and rigid material for functioning as described above.

An Apparatus and method for removing objects stuck to hard surfaces with various mastics is described above. Various details of the invention may be changed without departing from its scope. Furthermore, the foregoing description of the specific embodiments of the invention and the best mode for practicing the invention are provided for the purpose of illustration only and not for the purpose of limitation.

### KEY TO DRAWING NUMBERS

10) bucket-razor body of invention

11) angle slope to allow proper cutting angle, and to facilitate the smooth flow and movement of the cut material towards the bucket.

12) end of invention facing the bucket

13) end of invention facing away from bucket.

14) cutting or scraping blade

15) slot for receiving bucket bottom plate

20) bolts or set screws for tightening and holding invention to bucket plate

21) slot for receiving cutting or scraping blade.

22) counter sunk bolts or set screws for tightening and holding the cutting or scraping blade

23) 2 walls to hold invention onto bucket plate

24) angle slope to allow proper cutting, and to facilitate the smooth flow and movement of the cut material towards the bucket.

25a&b) handles for easy movement of the invention also used to guide cut materials in the bucket.

27) construction machine with a front-end loader attached with a bucket on the end.

28) common front-end loader bucket

29) bucket bottom plate

What is claimed is:

1. A method for removing objects adhered to hard surfaces. Such surfaces being, but not limited to, Asphalt and Concrete. Objects being, but not limited to, Pavement Marking Tape, Raised Pavement Markers and Ceramic Pavement Markers. Said Method comprising: Providing a unit with the ability to be attached to a front-end loader bucket, which in turn holds a knife like cutting blade, which can be repeatedly installed in and removed from the unit. With intent to remove these objects and most, if not all, of there holding mastics without doing any appreciable damage to the hard surface.

2 A unit capable of Holding a knife like cutting blade, which can be repeatedly installed in and removed from the unit. With intent to remove these objects and most, if not all, of there holding mastics without doing any appreciable damage to the hard surface.

3 A unit capable of Holding a knife like cutting blade, which can be repeatedly installed in and removed from the unit and which is self-sharping. With intent to remove these objects and most, if not all, of there holding mastics without doing any appreciable damage to the hard surface.

4 A unit capable of Holding a knife like cutting blade, which can be repeatedly installed in and removed from the unit. Which facilitates self-loading of cut material.
